(19) United States
(12) Patent Application Publication
(10) Pub. No.: US 2008/0299934 A1
(43) Pub. Date: Dec. 4, 2008

(54) COMMUNICATION MODULE HAVING A BIOMODULATOR

(76) Inventors: Tsung-Lang Lin, Taipei (TW); Hsiao Chi Yu, Taipei (TW)

Correspondence Address: G. LINK CO, LTD., 3550 BELL ROAD, MINOOKA, IL, 60447, US

(21) Appl. No.: 11/768,928

(22) Filed: Jun. 27, 2007

(30) Foreign Application Priority Data
Jun. 1, 2007 (TW) 096119712

(51) Int. Cl. H04B 10/06

(52) U.S. Cl. 455/317

(57) ABSTRACT

A communication module having a biomodulator is disclosed. The present invention includes a communication module and a biomodulator, wherein the communication module includes an electronic component assembly, which includes a plurality of electrical components capable of forming a communication device. The biomodulator formed on a side of the communication module is made of materials capable of generating molecular resonance effects under electromagnetic waves.

### FIELD OF THE INVENTION

The present invention relates to a communication module having a biomodulator, particularly a communication device capable of modulating biomagnetic fields in order to reduce the impact of electromagnetic waves on human biomagnetic fields, such that wireless transmission of electromagnetic waves will not cause interference in human biomagnetic fields and thus negative effects.

### BACKGROUND OF THE INVENTION

Signal loss often occurs during transmission of conventional wireless transmission devices due to the properties of antennae. Consequently, transmission power must be increased in order to effectively transmit radio frequency signals (RF signals) so that the signals can be transformed into effective RF wireless signals for transmission. In other words, the intensity of electromagnetic waves must be increased, thereby filling the air with invisible killers—electromagnetic waves.

Given the real presence of electromagnetic waves in air, the human biomagnetic field will be directly subject to the disturbances in the magnetic fields within the scope of effective transmission. Consequently, extended exposure under wireless transmission easily causes biological pathologies to the human body.

To overcome the harmful effects of electromagnetic waves on human health, the present invention provides a communication module having a biomodulator, such that users can enjoy wireless transmission safely, healthily and conveniently.

### SUMMARY OF THE INVENTION

Accordingly, an objective of the invention is to provide a communication module having a biomodulator, such that natural waveforms are free from the interference of electromagnetic waves generated by the communication module and the disturbances of the magnetic field, through the action of the biomodulator.

Alternatively, another objective of the invention is to provide a communication module having a biomodulator, wherein a configuration of a biomodulator is designed specially for high-intensity electromagnetic waves generated by the antenna of the communication module in order to reduce the harmful effects of electromagnetic waves generated by wireless devices on the human body.

Alternatively, another objective of the invention is to provide a communication module having a biomodulator, wherein a configuration and a structure of a biomodulator is designed specially for electromagnetic waves generated by electrical components of general mobile phones in order to reduce the harmful effects of electromagnetic waves generated by mobile phones on the human body.

To realize the above-mentioned objectives, the invention discloses a communication module having a biomodulator, including a communication module and a biomodulator. The communication module includes an electronic component assembly, which includes a plurality of electrical components capable of forming a communication device. The biomodulator provided on a side of the communication module is made of materials capable of generating molecular resonance effects under electromagnetic waves.

The communication module further includes a circuit board, wherein the electronic component assembly and the biomodulator are respectively provided on a top and a bottom face of the circuit board, and the circuit board is electrically coupled to a plurality of electrical components in the electronic component assembly. Moreover, the electronic component assembly includes a RF antenna, which is formed in a part of the circuit board. The biomodulator includes a bio-modulating member, which is formed on a bottom face of the circuit board corresponding to the RF antenna on a top face of the circuit board.

The bio-modulating member further includes a plurality of slots, which are cylindrical hollow parts formed by extending upward from a bottom face of the bio-modulating member, wherein the bio-modulating member is a constituted into a semi-oval structure. Each of the plurality of slots includes a first slot and a plurality of second slots. The first slot is formed in a center of the semi-oval structure of the bio-modulating member, and each of the second slots is partially formed around the semi-oval structure of the bio-modulating member and surrounds the first slot. Moreover, the internal diameter of the first slot is larger than that of the second slot.

The communication module further includes a body. The electronic component assembly includes a plurality of electrical components capable of forming a communication device. The body is disposed in a manner such that the body covers the electronic component assembly and the biomodulator, which is formed between the electronic component assembly and the body. The electronic component assembly further includes an antenna module, such that the antenna module and an electrical circuit are formed on a top surface of the circuit board. The biomodulator includes a plurality of cut-out portions corresponding to some components of the communication module. The communication module further includes a circuit board, wherein the electronic component assembly is provided on a top face thereof. The biomodulator is formed between a bottom face of the circuit board and an interior face of the body.

The biomodulator is preferably formed on an interior face of the body toward the bottom face of circuit board.

The electronic component assembly further includes a screen and a keyboard, such that the screen and the keyboard are formed on the bottom face of the circuit board. The plurality of cut-out portions in the biomodulator includes a first cut-out portion and a second cut-out portion, such that the first cut-out portion corresponds to the screen and the second cut-out portion corresponds to the keyboard.

The objects, features, and advantages of the present invention made apparent to those skilled in the art by referencing to the detailed description is given in the following embodiments in conjunction with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a side perspective view illustrating a first embodiment of a communication module having a biomodulator made according to the present invention;

FIG. 2 is a side perspective view illustrating a second embodiment of a communication module having a biomodulator made according to the present invention;

FIG. 3 is a side perspective view illustrating a third embodiment of a communication module having a biomodulator made according to the present invention;

FIG. 4 is a top-down perspective view of the third embodiment disclosed in FIG. 3 of the present invention;

FIG. 5 is a top-down perspective view illustrating a fourth embodiment of a communication module having a biomodulator made according to the present invention; and

FIG. 6 is a cross-sectional view of the fourth embodiment disclosed in FIG. 5 along the I-I cross-section.

### DETAILED DESCRIPTION OF THE INVENTION

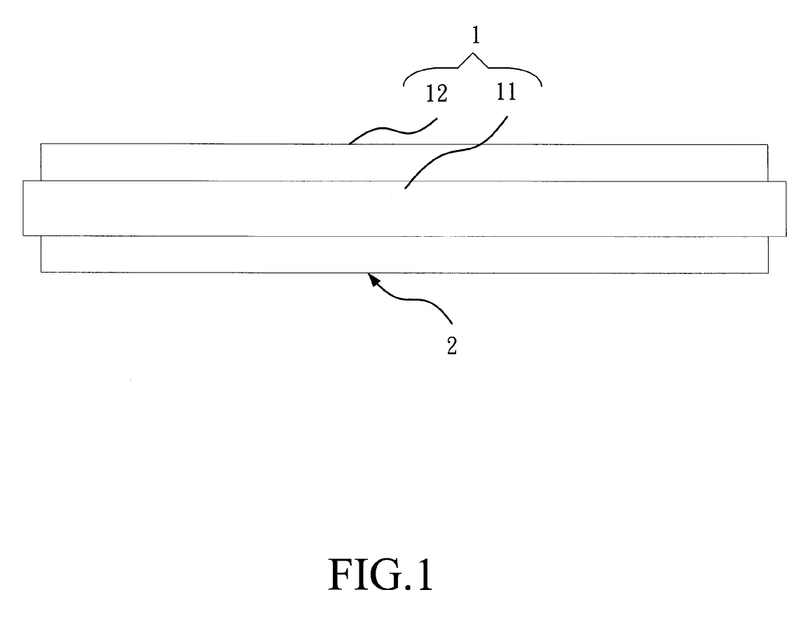

FIG. 1 illustrates a side perspective view illustrating a first embodiment of a communication module having a biomodulator made according to the present invention. The communication module having a biomodulator according to the present invention is formed by a communication module 1 and a biomodulator 2, wherein the communication module 1 includes an electronic component assembly 12, which includes a plurality of electrical components capable of forming a communication device. The biomodulator 2 is formed on a side of the communication module 1, and the biomodulator 2 is made of materials capable of generating molecular resonance effects under electromagnetic waves. When electromagnetic waves pass through the biomodulator 2, the surrounding electromagnetic waveforms are re-modulated, thereby keeping the original order of the bio-magnetic field near the electromagnetic waves.

The communication module 1 further includes a circuit board 11, wherein the electronic component assembly 12 and the biomodulator 2 are respectively formed on a top face and a bottom face thereof. The circuit board 11 provides electrical coupling required for electrical components of the electronic component assembly 12.

The biomodulator 2 is made of polar polymer materials capable of generating molecular resonance effects under electromagnetic waves. Upon sensing external electromagnetic signals, the polar polymer materials will respond with low-frequency bio-magnetic vibrations, which can modulate and neutralize the harmful electromagnetic signals generated by electrical appliances.

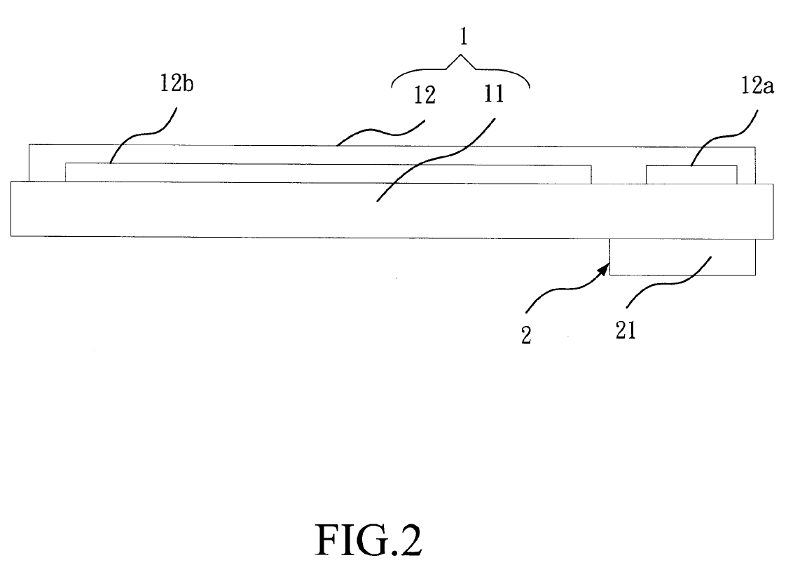

FIG. 2 is a side perspective view illustrating a second embodiment of a communication module having a biomodulator made according to the present invention. According to the embodiments of the present invention, the electronic component assembly 12 of the communication module 1 includes a RF antenna 12a and an electrical circuit 12b, such that the RF antenna 12a is formed on a part of the circuit board 11 for receiving or transmitting electromagnetic signals. The electrical circuit 12b is formed on another part of the circuit board 11 for processing electrical signals received from or transmitted by the RF antenna 12a. The electrical circuit 12b is capable of outputting electrical signals carrying messages to the RF antenna 12a, through which electromagnetic signals carrying the electrical signals are transmitted. Otherwise, the electromagnetic signals carrying electrical signals received by the RF antenna 12a are transformed into other electrical signals and inputted into the electrical circuit 12b, which processes signals and analyzes the electrical messages inputted by the electrical circuit 12b.

The biomodulator 2 includes a bio-modulating member 21 formed on a bottom face of the circuit board 11 corresponding to the RF antenna 12a on the top face of the circuit board 11.

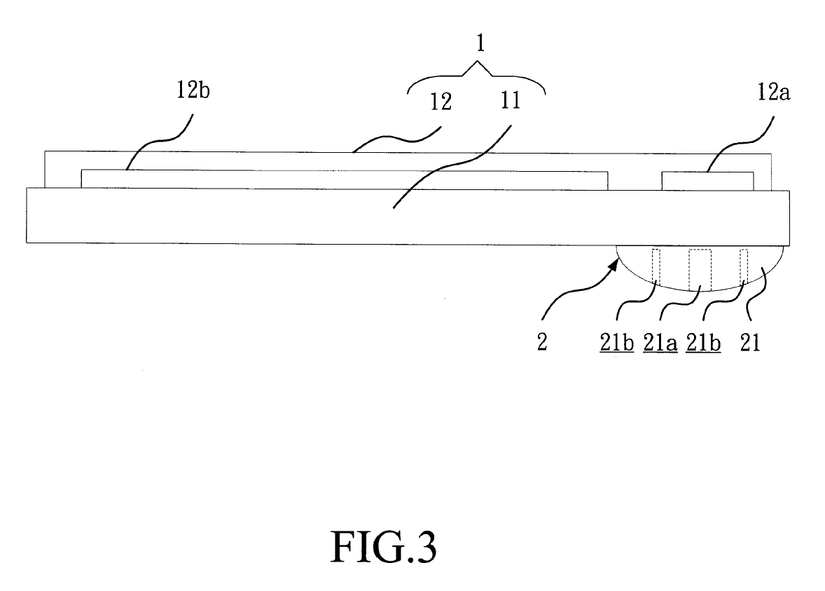

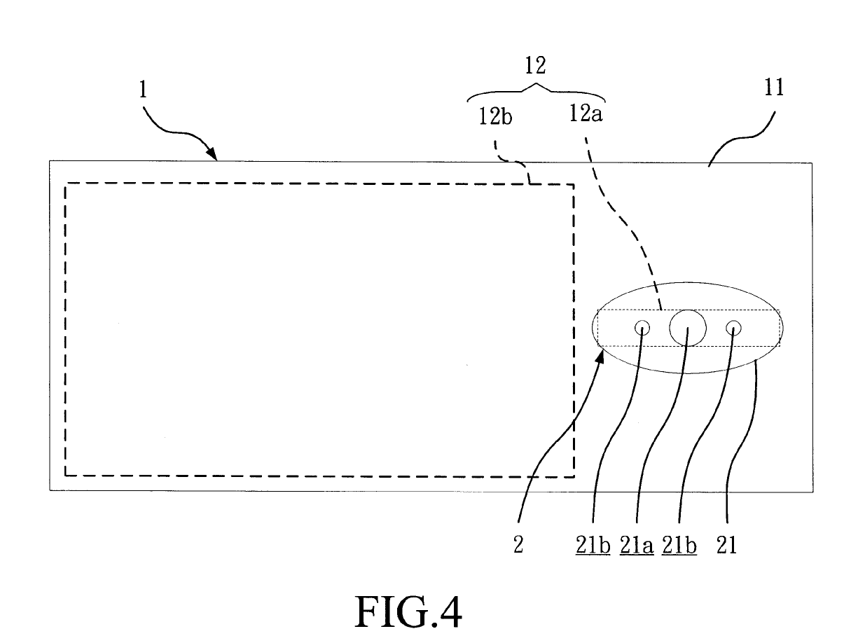

FIG. 3 is a side perspective view illustrating a third embodiment of a communication module having a biomodulator made according to the present invention, and FIG. 4 is a top-down perspective view of the third embodiment disclosed in FIG. 3 of the present invention. The biomodulator 2 of the embodiment includes a bio-modulating member 21, such that a top face of the bio-modulating member 21 is securely attached to a bottom face of the circuit board 11 of the communication module 1 such that the bio-modulating member 21 corresponds to the bottom of the RF antenna 12a in the circuit board 11 of the communication module 1. The bio-modulating member 21 further includes a plurality of slots, which are cylindrical hollow parts formed by extending upward from a bottom face of the bio-modulating member 21, such that electromagnetic waves generated by the electronic component assembly 12, particularly the electromagnetic waves generated by the RF antenna 12a, get into the slots. Therefore, the bio-modulating member 21 can improve its capability of generating molecular resonance effects and thus its molecular resonance effects.

The bio-modulating member 21 is constituted into a semi-oval structure. Among the plurality of slots, the slot in the center is defined as a first slot 21 and the slot located in the periphery is defined as a second slot 22, wherein the internal diameter of the first slot 21 is larger than that of the second slot 22.

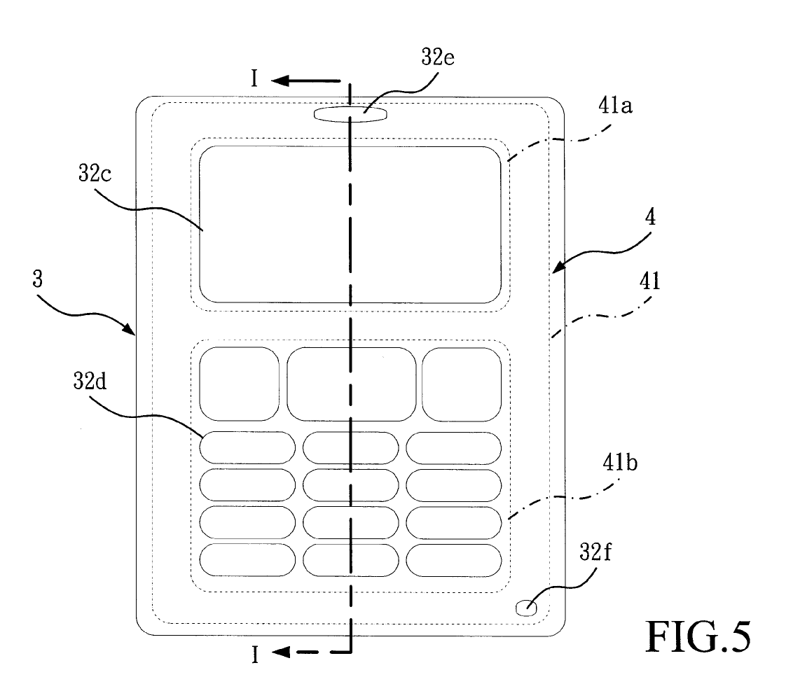

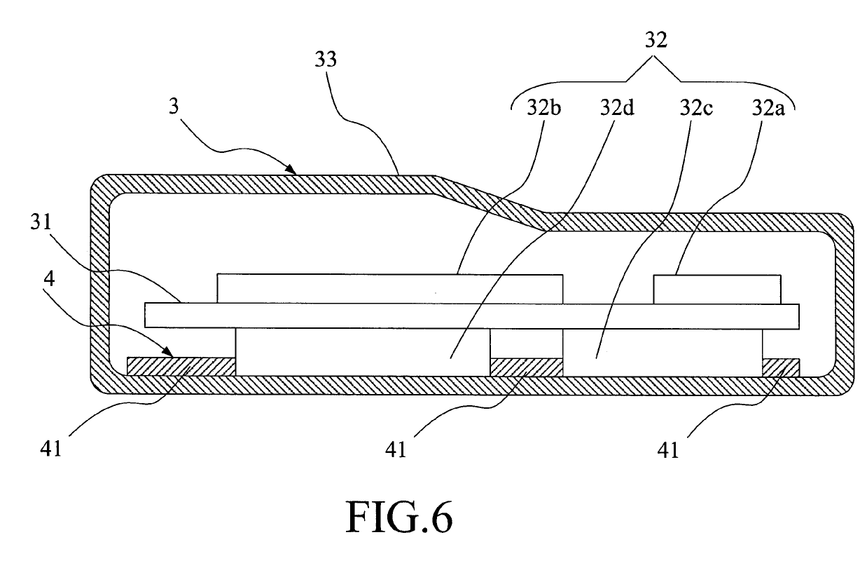

FIG. 5 is a top-down perspective view illustrating a fourth embodiment of a communication module having a biomodulator made according to the present invention; and FIG. 6 is a cross-sectional view of the fourth embodiment disclosed in FIG. 5 along the I-I cross-section. The present invention is formed by a communication module 3 and a biomodulator 4, wherein the communication module 3 includes an electronic component assembly 32 and a body 33. The electronic component assembly 32 includes a plurality of electrical components capable of forming a communication device. The body 33 is disposed in a manner such that the body 33 covers the electronic component assembly 32 and the biomodulator 4, which is formed between the electronic component assembly 32 and the body 33. The biomodulator 4 is made of materials capable of generating molecular resonance effects under electromagnetic waves. When electromagnetic waves pass through the biomodulator 4, the surrounding electromagnetic waveforms are re-modulated, thereby keeping the original order of the bio-magnetic field near the electromagnetic waves.

The communication module 3 further includes a circuit board 31. The electronic component assembly 32 further includes a RF antenna 32a, an electrical circuit 32b, a screen 32c, a keyboard 32d, an earphone portion 32e and a microphone portion 32f, wherein the RF antenna 32a and the electrical circuit 32b of the electronic component assembly 32 are formed on a top face of the circuit board 31. The screen 32c, the keyboard 32d, the earphone portion 32e and the microphone portion 32f of the electronic component assembly 32 are formed on a bottom face of the circuit board 31, wherein the circuit board 31 provides electrical coupling required for electrical components of the electronic component assembly 32. The RF antenna 32a is formed on a part of the circuit board 31 for receiving or transmitting electromagnetic signals. The electrical circuit 32b is formed on another part of the circuit board 31 for processing electrical signals for the communication module 3. The screen 32c is a graphic display device of the communication module 3, and the keyboard 32d is a message input device of the communication module 3. The earphone portion 32e is an audio output device of the communication module 3, and the microphone portion 32f is an audio input device of the communication module 3. Consequently, the electrical circuit 32b is capable of outputting electrical signals carrying messages to the RF antenna 32a, through which electromagnetic signals carrying electrical signals are transmitted. Otherwise, the electromagnetic signals carrying electrical signals received by the RF antenna 32a are transformed into other electrical signals and inputted into the electrical circuit 32b, which processes signals and analyzes the electrical messages inputted by the electrical circuit 32b. The biomodulator 4 includes a bio-modulating member 41, which is a plate body made of materials capable of generating molecular resonance effects under electromagnetic waves. The bio-modulating member 41 includes a plurality of cut-out portions in order to become separated from parts of the components in the communication module 3. Specifically, the bio-modulating member 41 is attached onto an internal face of the body 33 facing a bottom face of the circuit board 31. The plurality of cut-out portions in the bio-modulating member 41 include a first cut-out portion 41a and a second cut-out portion 41b, such that the first cut-out portion 41a corresponds to the screen 32c, and the second cut-out portion 41b corresponds to the keyboard 32d. In this way, the screen 32c and the keyboard 32d can respectively extend from the bottom face of the circuit board 31 to the body 33, such that the bio-modulating member 41 will not cause mechanical interference with the screen 32c and the keyboard 32d respectively.

Consequently, when the communication module 3 is operating, the biomodulator 41 generates molecular resonance effects under the electromagnetic waves generated inside the communication module 3, particularly the strong electromagnetic signals generated by the RF antenna 32a. When electromagnetic waves pass through the biomodulator 4, the surrounding electromagnetic waveforms are re-modulated, thereby keeping the original order of the bio-magnetic field near the electromagnetic waves.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A communication module having a biomodulator, comprising:
a communication module; and
a biomodulator;
wherein said communication module comprises an electronic component assembly, which comprises a plurality of electrical components capable of forming a communication device; and said biomodulator formed on a side of said communication module is made of materials capable of generating molecular resonance effects under electromagnetic waves.

2. The communication module having a biomodulator as claimed in claim 1, wherein said communication module further comprises a circuit board, such that said electronic component assembly and said biomodulator are respectively provided on a top and a bottom face of said circuit board, and said circuit board is electrically coupled to each of the plurality of electrical components in said electronic component assembly.

3. The communication module having a biomodulator as claimed in claim 2, wherein said electronic component assembly comprises a RF antenna, which is provided in a part of said circuit board; and said biomodulator comprises a bio-modulating member, which is formed on a bottom surface of said circuit board corresponding to said RF antenna formed on a top surface of said circuit board.

4. The communication module having a biomodulator as claimed in claim 3, wherein said bio-modulating member further comprises a plurality of slots, which are cylindrical hollow parts formed by extending upward from a bottom face of said bio-modulating member.

5. The communication module having a biomodulator as claimed in claim 4, wherein said bio-modulating member is constituted into a semi-oval structure.

6. The communication module having a biomodulator as claimed in claim 5, wherein each of said plurality of slots comprises a first slot and a plurality of second slots, such that said first slot is formed in a center of said semi-oval structure in said bio-modulating member, and each of said second slots is partially formed around said semi-oval structure in said bio-modulating member and surrounds said first slot.

7. The communication module having a biomodulator as claimed in claim 6, wherein the internal diameter of said first slot is larger than that of said second slot.

8. The communication module having a biomodulator as claimed in claim 1, wherein said communication module further comprises a body; said electronic component assembly comprises a plurality of electrical components capable of forming a communication device; said body is disposed in a manner such that said body covers said electronic component assembly and said biomodulator which is formed between said electronic component assembly and said body.

9. The communication module having a biomodulator as claimed in claim 8, wherein said electronic component assembly further comprises an RF antenna, such that said antenna and an electrical circuit are formed on a top surface of said circuit board; said biomodulator comprises a plurality of cut-out portions corresponding to some components of said communication module, respectively.

10. The communication module having a biomodulator as claimed in claim 9, wherein said communication module further comprises a circuit board, such that said electronic component assembly is formed on a top face of said circuit board; and said biomodulator is formed between a bottom face of said circuit board and an interior face of said body.

11. The communication module having a biomodulator as claimed in claim 9, wherein said communication module further comprises a circuit board; said electronic component assembly is formed on a top face of said circuit board; and said biomodulator is formed on an interior face of said body toward the bottom face of said circuit board.

12. The communication module having a biomodulator as claimed in claim 9, wherein said electronic component assembly further comprises a screen and a keyboard, such that said screen and said keyboard are formed on a bottom face of said circuit board; said plurality of cut-out portions in said biomodulator comprises a first cut-out portion and a second cut-out portion, such that said first cut-out portion corresponds to said screen and said second cut-out portion corresponds to said keyboard.

13. The communication module having a biomodulator as claimed in claim 1, wherein said biomodulator is made of a polar polymer, which is a particular high dielectric.
